(19) United States
(12) Patent Application Publication
(10) Pub. No.: US 2021/0221750 A1
(43) Pub. Date: Jul. 22, 2021

(54) AGRICULTURAL COMPOSITION CONTAINING SI CLAY

(71) Applicant: HELENA AGRI-ENTERPRISES, LLC, Collierville, TN (US)

(72) Inventors: Chris ALBRIGHT, Jensen Beach, FL (US); Curt MATHEWS, Lake Placid, FL (US); John POLHILL, Clewiston, FL (US)

(21) Appl. No.: 17/223,826

(22) Filed: Apr. 6, 2021

Related U.S. Application Data
(63) Continuation of application No. 16/878,100, filed on May 19, 2020.
Application No. 16/878,100 is a continuation-in-part of application No. 16/681,010, filed on Nov. 12, 2019.
(60) Provisional application No. 62/776,560, filed on Dec. 7, 2018.
(60) Provisional application No. 62/767,743, filed on Nov. 15, 2018.

(51) Int. Cl. C05D 9/00; C05G 5/12; C05G 3/00

(52) U.S. Cl. CPC C05D 9/00; C05G 3/00; C05G 5/12

(57) ABSTRACT

An agricultural composition containing a) about 10 to about 90% by weight of Si clay granules or Si clay powders based on the amount of the composition and
b) inorganic or organic acids,
   and wherein the composition has a pH of 2 to 5. The agricultural composition does not have to contain an insecticide. A process of treating a plant which by applying the agricultural composition which contains Si clay granules or powders wherein the composition is applied in an amount from about 150 pounds to about 4,000 pounds per acre.

### CROSS-REFERENCE TO RELATED APPLICATIONS

This application is a continuation-in-part to U.S. Ser. No. 16/878,100 filed May 19, 2020 ('100 application). The '100 application is incorporated by reference in its entirety for all useful purposes. The '100 application is a continuation-in-part to U.S. Ser. No. 16/681,010 filed Nov. 12, 2019 ('010 application). The '010 application is incorporated by reference in its entirety for all useful purposes. The '010 application claims benefit to U.S. Provisional application No. 62/776,560 filed Dec. 7, 2018 and U.S. Provisional application No. 62/767,743 filed Nov. 15, 2018 and which are both incorporated by reference in their entirety for all useful purposes.

### BACKGROUND OF THE INVENTION

Silicon “Si” is considered a “functional” or “beneficial” (rather than essential) plant nutrient. In Florida, Si amendments may increase cane and sugar yields as much as 25% and may support more successful ratoon crops.

Adding a soil amendment, also called a soil conditioner, helps improve plant growth and health. The type of amendment or amendments added depends on the current soil composition, the climate, and the type of plant. Some of the various amendments include:

1. Lime (makes soil less acidic)
2. Fertilizers for plant nutrients (i.e. manure, peat, or compost)
3. Materials for water retention (i.e. clay, shredded hark, or vermiculite)
4. Gypsum (releases nutrients and improves structure)
5. Clay (allows water to reach the plant root).

Various elements, which are normally drawn from the soil, are known to be essential to plant nutrition. These elements include: nitrogen (N), phosphorus (P), potassium (K), sulfur (S), calcium (Ca), magnesium (Mg), iron (Fe), manganese (Mn), copper (Cu), cobalt (Co), zinc (Zn), boron (B), nickel (Ni), molybdenum (Mo), and chlorine (Cl). Of these elements, nitrogen, phosphorus, potassium, sulfur, calcium, and magnesium are needed by plants in relatively large quantities and are therefore called macronutrients. The remaining members of the group (iron, manganese, copper, cobalt, zinc, boron, nickel, molybdenum, and chlorine) are known as micronutrients since they are required in very small amounts for plant growth.

Supplying a plant's major nutrient needs (nitrogen, phosphorus, potassium-N—P—K) is most effective and economical via soil application. However, foliar application has proven to be an excellent method of supplying plant requirements for secondary macronutrients (sulfur, calcium, magnesium) and micronutrients (carbon (C), hydrogen (H), and oxygen (O), nitrogen (N), phosphorus (P) and potassium (K), while supplementing N—P—K needs for short and/or critical growth stage periods. Additionally, the so called micronutrients, also commonly provided by mineral fertilizers are: boron (B), chlorine (Cl), copper (Cu), iron (Fe), manganese (Mn), zinc (Zn) and molybdenum (Mo). Foliar application refers to the application of plant nutrients to above-ground plant parts. Foliar fertilization programs prolong the fertilizing application period, providing a continuous supply of nutrients when crop demand is at a maximum, and can be an economical way to boost yield.

In fertilization programs, sulfate metal salts (e.g., zinc sulfate, manganese sulfate, and copper sulfate) are an economical source affording both sulfur and micronutrients.

Humectants have also been used to help retain water within the soil and plant tissue. These features make the incorporation of a humectant into a foliar fertilizer potentially beneficial to the needs of the plant.

Si applications with sugarcane have been discussed in detail in the publication, Savant, N. K, Korndorfer, G. H., Datnoff, L. E. and Snyder, G. H. 1999. Silicon Nutrition And Sugarcane Production: A Review, J. Plant Nutr. 22 (12):1853-1903 (Savant) which is incorporated by reference. Savant disclose the using silicate slag and calcium silicate slag as the source of Si for sugarcane.

Calcium silicate slag, a popular Si source, tends to have low solubility under high soil pH conditions. Growers have experimented with Ca-silicate slag applications for many years. This collective experience suggests that when soils test low for acetic acid extractable Si (less than 10 ppm in the soil extract), a 3 ton/Acre application of Ca-silicate slag will likely support favorable yield improvements over a three-crop cycle. A three-crop cycle is where the same crop is grown for three years. The Si source is generally broadcast applied and disked into the soil prior to planting.

Leaf Si analysis is very useful in combination with soil test Si values in determining the need for calcium silicate application.

Deficiency symptoms: Si deficiency is characterized by minute, circular white leaf spots (freckles). The freckling is more severe on older leaves. Older leaves may senesce prematurely, and the stools exhibit poor tillering and ratooning characteristics.

The philosophy that drives this is one identified by the American Society of Agronomists and is called the 4R's.
Right product
Right rate
Right timing
Right place

Current practices of adding silicon has been reduced to a soil amendment process and only applied prior to planting, (sugarcane is planted once in 3 years and yields three crops, one per year). This application requires 1-3 tons per acre every 3-4 years and in 2018 costs up to $200 per acre. Not only is this an expensive input, but one that runs contrary to the concept of the 4R's.

Agsorb® is a clay-based granules from Oil-Dri Corporation of America (Oil-Dri), has been used in the fertilizer industry as a fertilizer blend conditioning agent. Fertilizer salts by virtue of their properties absorb moisture and this phenomenon is exasperated when certain fertilizer materials are blended together and so the need for a conditioning agent. Agsorb® can mitigate the impact of excessive moisture in a blend, preserving manageable application properties of the blend for the grower. Agsorb® is granules that include Montmorillonite from Ripley Miss. or from Mounds Ill., Attapulgite from Ochlocknee Ga., Hysrous Aluminosilicate from Taft, Calif. Below is the technical sheets for the above material from Oil-Dri shown in Tables 1 (granules) and Table 2 (powders).

TABLE 1
Granules

| | | | | | Liquid | | | | | | |
|---|---|---|---|---|---|---|---|---|---|---|---|
| | | | | | Holding | Bulk | | Moisture | | Attrition | |
| Production | | | Size Guide | Uniformity | Capacity | Density | pH | Content | Particle | % | |
| Location & | | | Number Ps | Index Ps | Wt % | Lbs/Ft³ | In | Wt % | Count | Resistance | |
| Mineral | Product | Process | 006.01.01 | 006.01.01 | E1521-93 | E1521-91 | 001.01.01 | D2216-80 | E1520-93 | P-A 1056 | Available |
| Classffication | Name | Options | (GSA) | (GSA) | (ASTM) | (ASTM) | (ODC) | (ODC) | (ASTM) | B (GSA) | Colors |
| Ripley, MS | 30/60 | RVM | 40 | 50 | 31 | 37 | 5 | 7 | 10.1 | 75-85 | GRAY |
| MONT- | | | | | | | | | | | |
| MORILLONITE | | | | | | | | | | | |
| | 24/48 | LVM | 55 | 45 | 33 | 36 | 5 | <3 | 8.6 | 85-90 | GRAY |
| | | | | | | | | | | | OR RED |
| | 16/30 | LVM | 85 | 50 | 33 | 36 | 5 | <3 | 1.6 | 85-90 | GRAY |
| | 8/16 | LVM | 170 | 55 | 33 | 35 | 5 | <3 | 0.4 | 85-90 | GRAY |
| | | | | | | | | | | | OR RED |
| | 5/20 | LVM | 215 | 25 | 33 | 35 | 5 | <3 | 0.5 | 85-90 | GRAY |
| | | | | | | | | | | | OR RED |
| | 40/100 | LVM | ALPINE SIEVE PS | | 33 | 37.5 | 5 | 1.5 | 18 | 85-90 | GRAY |
| | | | 006.01.01 (GSA) | | | | | | | | OR RED |
| | | | 90%-325/+120 MESH | | | | | | | | |
| Ochlocknee, GA | 24/48 | LVM | 55 | 40 | 35 | 32 | 6 | <3 | 9.0 | 80-90 | LIGHT |
| ATTAPULGITE | | | | | | | | | | | GRAY |
| | 16/30 | RVM | 85 | 50 | 32 | 33 | 7 | 12 | 1.8 | 75-85 | TAN |
| | 16/30 | LVM | 85 | 50 | 35 | 32 | 6 | <3 | 1.6 | 80-90 | LIGHT |
| | | | | | | | | | | | GRAY |
| | 12/24 | LVM | 110 | 60 | 35 | 31 | 6 | <3 | 0.9 | 80-90 | LIGHT |
| | | | | | | | | | | | GRAY |
| | 8/16 | LVM | 170 | 55 | 35 | 31 | 6 | <3 | 0.4 | 80-90 | LIGHT |
| | | | | | | | | | | | GRAY |
| | 5/20 | LVM | 215 | 25 | 35 | 32 | 6 | <3 | 0.6 | 80-90 | LIGHT |
| | | | | | | | | | | | GRAY |
| Taft, CA | 24/48 | RVM | 55 | 40 | 27 | 39 | 8 | <6 | 5.0 | 75-85 | TAN |
| HYDROUS | | | | | | | | | | | |
| ALUMINOSILICATE | | | | | | | | | | | |
| | 16/30 | RVM | 85 | 50 | 27 | 38 | 8 | <5 | 1.2 | 75-85 | TAN |
| | 5/20 | RVM | 215 | 25 | 27 | 40 | 8 | <5 | 0.4 | 75-85 | TAN |

TABLE 2
Powders

| | | | | Packed | | |
|---|---|---|---|---|---|---|
| | | | | Bulk | | |
| | | | Alpine | Density | | Moisture |
| Production | | | Sieve | Lbs/Ft³ | pH | Content |
| Location & | | | Ps | 23-Nf- | In | Wt % |
| Mineral | Product | Process | 006.01.01 | 18-Usp1 | 001.01.01 | D2216-80 |
| Classification | Name | Options | (GSA) | (USP) | (ODC) | (ODC) |
| Ochlocknee, | −325 | RVM | 80% −325 mesh | 43 | 7 | 15 |
| GA | | | | | | |
| ATTAPULGITE | | | | | | |
| | −325 | LVM | 80% −325 mesh | 38 | 7 | 5 |
| | −325 | ULT | 80% −325 mesh | 37 | 6 | 3 |
| Mounds, IL | −325 | RVM | 80% −325 mesh | 43 | 5 | 10 |
| MONT- | | | | | | |
| MORILLONITE | | | | | | |
| | −325 | LVM | 80% −325 mesh | 40 | 5 | 3 |

In 2018, on the SDS sheets for Agsorb® had a 70% SiO₂ guarantee and thought that since it was already sized and designed to be added to blend granular fertiizer, what if we could render the crop required Si from this source?

Verge™ from Oil-Dri has durable outer core that prevents tiny fragments from breaking off, unlike traditional, irregular-shaped granules that rub together during handling, transportation, and formulation. Verge™ technical specifications are shown in Table 3.

TABLE 3

| | | S | N |
|---|---|---|---|
| | LPHD | Slow | Non- |
| | disintegrating | disintegrating | disintegrating |
| density | 48.5 | 48 | 46 |
| dust index | <0.3 | <0.3 | <0.3 |
| hardness | 94 | 93 | 96 |
| liquid hold capacity | 22 | 23 | 25 |
| moisture | 5 | 6 | 2 |
| pH | 6 | 5 | 5 |
| | SGN 100 | SGN140 | SGN200 |
| mesh size | 16/30 | 12-20 | 8/16 |
| uniformity index | −60 | −60 | −60 |
| angle of repose | 27° | 25° | 25° |
| Granlues per lb. | −900 k/lb | −400 k/lb | −200 k/lb |

U.S. Patent Publication No. 2017/0360029, which is incorporated by reference, discloses a chemical agent for controlling soil nematode. In formulation example 5 uses attapuligite as a carrier.

U.S. Patent Publication No. 2013/0210624 ('624 publication) which is incorporated by reference, discloses granular material employed as a fungicide or a fertilizer or both, comprising phosphorous acid (H₃PO₃) or phosphite (which may include HPO₃), along with a metal and phosphate on a granular carrier; or a mixture of a phosphite product and a phosphate product on a granular carrier; or mixture of a metal phosphite product and phosphate on a granular carrier. The mixture may contain a chelated metal on a granular carrier. Another mixture includes a phosphite product on a first granular carrier, and a phosphate product on a second granular carrier wherein the two are mixed and the phosphite product and the phosphate product may or may not include a metal ion. Alternatively, the mixture may also contain a chelated metal on a third granular carrier.

The '624 publication discloses in paragraph no. [0054] clay-based granules such as that sold by Oil-Dri Corporation as Verge™ may be formulated to disintegrate at an extremely fast rate such as one minute, or to dissolve far more slowly into thousands of microparticles. The '624 publication in paragraph no. [0018] requires the use of a growth promoting material or a biological.

US 2016/0050930 A (published Feb. 5, 2016) to Benfatti et. al. (referenced hereinafter as “BEN”). BEN relates to the a method of controlling insects (in particular insects of the order Hemiptera, especially aphids and whitefly) that are resistant to neonicotinoid insecticides and requires the use of a compound according to formula (1):

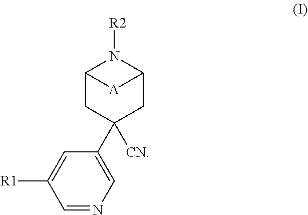

wherein
A is —CH₂—CH₂— or —CH═CH—;
R¹ is halogen; and
R² is hydrogen, formyl, cyano, hydroxy, NH, C₁-C₆ alkyl (optionally substituted by aryl, aryloxy, heteroaryl or hetero-cyclyl, which themselves can be optionally substituted by one to three substituents independently selected from halogen, cyano, nitro, C₁-C₄alkyl, C₁-C₄haloalkyl, and C₁-C₄alkoxy), C₁-C₆ haloalkyl (optionally substituted by one to two sub-stituents independently selected from hydroxy, C₁-C₄-alkoxy, tri(C₁-C₄alkyl)silyloxy, C₁-C₂alkylcarbonyloxy, and C₃-C₅ alkenyl), C₁-C₆ cyanoalkyl, C₁-C₆ alkoxy(C₁-C₆)alkyl (optionally substituted by aryl or heteroaryl, which themselves can be optionally substituted by one to three substituents independently selected from halogen, cyano, nitro, C₁-C₄alkyl, C₁-C₄haloalkyl, and C₁-C₄ alkoxy), C₁-C₄alkoxy(C₁-C₄)alkoxy(C₁-C₄)alkyl, C₁-C₆ alkylcarbonyl(C₁-C₆)alkyl, C₁-C₄ alkoxyimino(C₁-C₄)alkyl, C₁-C₄ haloalkoxy(C₁-C₄)alkyl, C₁-C₆ alkoxycarbonyl(C₁-C₆)alkyl, C₁-C₄alkoxy(C₁-C₄) alkoxycarbonyl(Q-C₆)alkyl, hydroxycarbonyl(C₁-C₆)alkyl, aryloxycarbonyl(C₁-C₆)alkyl (wherein the aryl group can be optionally substituted by one or two substituents independently selected from halogen, cyano, nitro, C₁-C₄alkyl, C₁-C₄ haloalkyl, and C₁-C₄ alkoxy), C₁-C₄ alkylaminocarbonyl(C₁-C₆)alkyl, di(C₁-C₄ alkyl)aminocarbonyl(C₁-C₆)alkyl, C₁-C₄haloalkylaminocarbonyl(C₁-C₆)alkyl, di(C₁-C₄ haloalkyl)aminocarbonyl-C₁-C₆ alkyl, C₁-C₂ alkoxy(C₂-C₄)akylaminocarbonyl(C₁-C₄)alkyl, C₂-C₆ alkenyloxycarbonyl(C₁-C₆) alkyl, C₃-C₆ alkynyloxycarbonyl(C₁-C₆)alkyl, (R³O)₂(O═)P(C₁-C₆)alkyl where R³ is hydrogen, C₁-C₄ alkyl or benzyl, C₃-C₇ cycloalkyl (optionally substituted by one to three substituents independently selected from C₁-C₄ alkyl, C₁-C₄ haloalkyl, and C₁-C₄ alkoxy and, additionally, one of the ring member units can optionally represent C═O or C═NR⁴ where R⁴ is hydrogen, C₁-C₄ alkyl, C₁-C₄ haloalkyl, C₁-C₄ cyanoalkyl, C₁-C₄ alkoxy, or C₃-C₆ cycloalkyl), C₃-C₇ halocycloalkyl, C₃-C₇ cycloalkenyl (optionally substituted by one or two substituents independently selected from C₁-C₄ alkyl, and C₁-C₄ haloalkyl, and, additionally, one of the ring member units can optionally represent C═O), C₃-C₇ halocycloalkenyl, C₁-C₆ alkyl-S(═O)n¹(C₁-C₆)alkyl where n¹ is 0, 1 or 2 (optionally substituted by aryl or heteroaryl or heterocyclyl, which themselves can be optionally substituted by one to three substituents independently selected from halogen, cyano, nitro, C₁-C₄ alkyl, C₁-C₄ haloalkyl, and C₁-C₄ alkoxy), C₃-C₆ alkenyl, C₃-C₆ haloalkenyl, aryl(C₃-C₆)alkenyl, C₃-C₆ alkynyl, C₃-C₆ haloalkynyl, aryl(C₃-C₆)alkynyl, C₃-C₆hydroxyalkynyl, C₁-C₆ alkoxycarbonyl (optionally substituted by one to three substituents independently selected from halogen, hydroxy, cyano, C₁-C₄alkoxy, C₁-C₄haloalkyl, and aryl), aryloxycarbonyl (optionally substituted by one to three substituents independently selected from halogen, cyano, nitro, C₁-C₄alkyl, C₁-C₄haloalkyl, C₁-C₄alkoxy), C₃-C₆ alkenyloxycarbonyl, C₃-C₆alkynyloxycarbonyl, C₁-C₆alkylcarbonyl, C₁-C₆haloalkylcarbonyl, aminocarbonyl, C₁-C₆alkylaminocarbonyl, di(C₁-C₆)alkylaminocarbonyl, aminothiocarbonyl, C₁-C₆alkylaminothiocarbonyl, di(C₁-C₆)alkylaminothiocarbonyl, C₁-C₆alkoxy, C₃-C₆ alkenyloxy, C₃-C₈alkynyloxy, aryloxy (optionally substituted by one to three substituents independently selected from halogen, cyano, nitro, C₁-C₄alkyl, C₁-C₄haloalkyl, and C₁-C₄alkoxy), C₁-C₆alkylamino, di(C₁-C₆)alkylamino, C₃-C₆cycloalkylamino, C₁-C₄alkylthio, C₁-C₄alkylsulfinyl, C₁-C₄alkylsulfonyl, C₁-C₄haloalkylsulfonyl, aryl-S(═O)n² (optionally substituted by one or two substituents independently selected from halogen, nitro, and C₁-C₄alkyl) where n² is 0, 1 or 2, aryl (optionally substituted by one to three substituents independently selected from halogen, cyano, nitro, C₁-C₄alkyl, C₁-C₄haloalkyl, C₁-C₄alkoxy, and C₁-C₄haloalkoxy), heteroaryl (optionally substituted by one to three substituents independently selected from halogen, cyano, nitro, C₁-C₄alkyl, C₁-C₄haloalkyl, C₁-C₄alkoxy, and C₁-C₄haloalkoxy), heterocyclyl (optionally substituted by one to three substituents independently selected from halogen, cyano, nitro, C₁-C₄alkyl, C₁-C₄haloalkyl, C₁-C₄alkoxy, and C₁-C₄haloalkoxy, and, additionally, a ring member unit can optionally represent C═O or C═NR⁵ where R⁵ is hydrogen, C₁-C₄ alkyl, C₁-C₄ haloalkyl, C₁-C₄ cyanoalkyl, C₁-C₄ alkoxy, or C₃-C₆ cycloalkyl), (C₁-C₆ alkylthio)carbonyl, (C₁-C₆ alkylthio)thiocarbonyl, C—C alkyl-S(═O)n³ (═NR⁶)—C₁-C₄alkyl wherein R⁶ is hydrogen, cyano, nitro, C₁-C₄alkyl and n³ is 0 or 1, or R² represents a group “—C(R⁷)(R⁸)(R⁹)” wherein R⁷ is C₁-C₄alkyl, C₁-C₄haloalkyl, or cyclopropyl, R⁸ is hydrogen, C₁-C₄alkyl, C₁-C₄haloalkyl, or cyclopropyl, preferably hydrogen, R⁹ is cyano, C₁-C₄alkyl, C₂-C₆ alkenyl, C₂-C₆haloalkenyl, C₁-C₄alkoxy, C₂-C₅ alkynyl, C₂-C₄alkoxycarbonyl, C₁-C₄alkylaminocarbonyl, di(C₁-C₃ alkyl)aminocarbonyl, C₁-C₂haloalkylaminocarbonyl, C₃-C₆alkenyloxycarbonyl, C₃-C₄ alkynyloxycarbonyl, or C₁-C₃ alkylcarbonyl; (arylthio)carbonyl(C₁-C₆)alkyl(wherein aryl can be optionally substituted by one to three substituents independently selected from halogen, cyano, nitro, C₁-C₄ alkyl, C₁-C₄ haloalkyl, and C₁-C₄ alkoxy), (C₁-C₃ alkylthio)carbonyl(C₁-C₆)alkyl (optionally substituted by aryl or heteroaryl or heterocyclyl, which themselves can be optionally substituted by one to three substituents independently selected from halogen, cyano, nitro, C₁-C₄ alkyl, C₁-C₄ haloalkyl, and C₁-C₄ alkoxy), or an agrochemically acceptable salt, N-oxide or isomer thereof. BEN is incorporated by reference in its entirety for all useful purposes.

U.S. Publication 2020/0079702 ('702 publication) relates to a humic substance based Si-fertilizer product having storage-stable, bio-available Si, which is produced by forming a mixture of, 45-95% by weight of a humic acid-containing raw material, 5-50% by weight of amorphous silica, and 0.5-10% by weight of an alkali, all amounts based on the total weight of the dry components, incubated in an aqueous medium, and optionally dried and granulated, wherein the bio-available silicon is in the form of water-soluble chelates of monosilicic acid-humate compounds.

The '702 publication in paragraph no. [0010] requires 0.5 to 10% by weight of an alkali incubated in an aqueous medium which is not required and can be excluded in our compositions. In addition, “the bio-available silicon is in the form of water-soluble chelates of monsilicic acid-humate compounds” are also are not required or can be excluded from our compositions.

### SUMMARY OF THE INVENTION

It is an object of the invention to find Si source(s), preferably in granular form that could be added to an agriculture composition and can be applied to the ground surface. The agricultural composition can optionally contain a fertilizer, in particular to a granular fertilizer.

Another object is to apply the agriculture composition according to the invention containing the granular Si can be applied in a band or (starter) application, broadcast application or strip placement application. A band or starter application is the placement of the agricultural formation in the same area as the seed. A broadcast application is the general distribution of the agricultural composition over the entire soil surface. A strip placement is the placement of the agricultural composition in narrow strips. Crops will differ with placement and spacing. For example, spacing in sugarcane is 60″ and with multiple applications could be placed about 2″ to about 12″ at plant in the drill or placed on the soil surface with supplement applications after cane has been planted.

The agricultural composition that contains Si source then could be applied at the same time as other fertilizers. It can be applied in one application or multiple applications, such as, but not limited to: 2, 3, 4, 5, 6, etc. applications a year. By applying the agricultural composition would complement the concept of the 4R's, thereby maximizing input efficiencies, get better yields and quality and probably save the grower money.

An object of the invention was to be able to reduce the amount of fertilizer blends used on the fields and to save the grower's time from applying the product. Therefore, there would be less product placed on the fields and this would give the grower more time.

The advantages would be as follows:
The product can travel with all fertilizer blends thereby eliminating the soil amendment of 1-3 tons.
   This opens the door to evaluate for optimum timing and rates of Si for example with sugarcane which is fertilized 2-5 times annually.
   This opens the door to evaluate for optimum placement of Si in conjunction with the growth stage of the crop.
Instead of 1-3 tons per acre, equivalent Si input would only require about 250 to about 750 (respectively) pounds per acre with half the cost.
In conjunction with supplying Si to the crop, when applied at 750 lbs per acre into the planting drill, the absorbent properties of the product would serve to hold moisture around the seed-piece.

Another embodiment of the invention relates to an agricultural composition comprising Si clay granules or Si clay powders wherein the Si clay granules or Si clay particles are in an amount from about 10 to about 90% by weight based on the total amount of the composition and Si clay and contain acids such as organic or inorganic acids. The agricultural composition has a pH in the range of about 2 to about 5 including 2, 3, 4, or 5. The agricultural composition according to the invention can exclude growth materials, a biologicals such as auxin or seaweed alginate, or an insecticide, in particular, one of the formula (I) of BEN (described above)

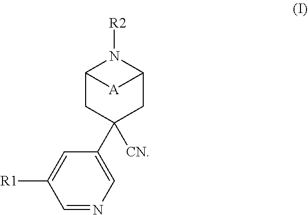

Inorganic acids include mineral acids selected from the group consisting of nitric acid, phosphoric acid, sulfuric acid, and mixtures thereof; and phosphorous acid or ammonia or a mixture thereof or phosphorous acid and/or ammonia can also be used in combination with the mineral acids.

Organic acids are preferably fulvic acid, humic acid, citric acid and carboxylic acid, preferably C₁ to C₂₀ carboxylic acid.

Rendering the Si into the plant is a two-step process. First, the acidification of the crops root zone serves to free bound Si (SiO₄) in the native environment. Second, the proprietary ratios of organic acids and other acids serve to help the plant mine SiO₂, native and AgSorb based, converting it to plant active silicic acid.

The agricultural composition or fertilizer composition can contain micronutrients and macronutrients as discussed above in the background of the invention section of the application.

The invention also relates to a process of fertilizing a plant which comprises applying the fertilizer to the ground (soil).

The invention also relates to a process of treating a plant which comprises applying the agricultural composition according to the invention to the ground (soil).

An embodiment 1 of the invention is to a process of treating a plant which comprises applying an agricultural composition which comprises Si clay granules or powders wherein the composition is applied in an amount from about 150 pounds to about 4,000 pounds per acre.

Again, the invention works without the use of insecticides, in particular without the compounds of the formula (1)

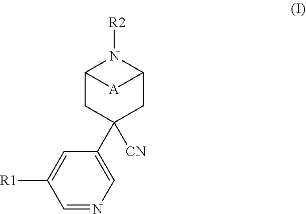

as described in BEN above.

### Embodiment 1

An agricultural composition which comprising

a) about 10 to about 90% by weight of Si clay granules or Si clay powders based on the amount of the composition and
b) inorganic or organic acids,
and wherein the composition has a pH of 2 to 5 and
with the proviso that the composition does not contain a compound of the formula (I)

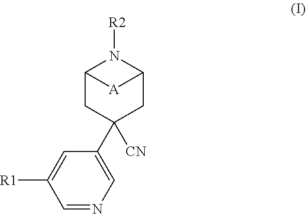

A is —CH₂—CH₂— or —CH═CH—;

R¹ is halogen; and

R² is hydrogen, formyl, cyano, hydroxy, NH, C₁-C₆ alkyl (optionally substituted by aryl, aryloxy, heteroaryl or hetero-cyclyl, which themselves can be optionally substituted by one to three substituents independently selected from halogen, cyano, nitro, C₁-C₄ alkyl, C₁-C₄ haloalkyl, and C₁-C₄ alkoxy), C₁-C₆ haloalkyl (optionally substituted by one to two substituents independently selected from hydroxy, C₁-C₄-alkoxy, tri(C₁-C₄alkyl)silyloxy, C₁-C₂alkylcarbonyloxy, and C₃-C₅ alkenyl), C₁-C₆ cyanoalkyl, C₁-C₆ alkoxy(C₁-C₆) alkyl (optionally substituted by aryl or heteroaryl, which themselves can be optionally substituted by one to three substituents independently selected from halogen, cyano, nitro, C₁-C₄alkyl, C₁-C₄haloalkyl, and C₁-C₄ alkoxy), C₁-C₄ alkoxy(C₁-C₄)alkoxy(C₁-C₄)alkyl, C₁-C₆ alkylcarbonyl(C₁-C₆)alkyl, C₁-C₄alkoxyimino(C₁-C₄)alkyl, C₁-C₄ haloalkoxy(C₁-C₄)alkyl, C₁-C₆ alkoxycarbonyl(C₁-C₆)alkyl, C₁-C₄ alkoxy(C₁-C₄) alkoxycarbonyl(C₁-C₆)alkyl, hydroxycarbonyl(C₁-C₆)alkyl, aryloxycarbonyl(C₁-C₆)alkyl (wherein the aryl group can be optionally substituted by one or two substituents independently selected from halogen, cyano, nitro, C₁-C₄alkyl, C₁-C₄ haloalkyl, and C₁-C₄ alkoxy), C₁-C₄ alkylaminocarbonyl(C₁-C₆)alkyl, di(C₁-C₄ alkyl)aminocarbonyl(C₁-C₆)alkyl, C₁-C₄haloalkylaminocarbonyl(C₁-C₆)alkyl, di(C₁-C₄ haloalkyl)aminocarbonyl-C₁-C₆ alkyl, C₁-C₂ alkoxy(C₂-C₄)alkylaminocarbonyl(C₁-C₄)alkyl, C₂-C₆ alkenyloxycarbonyl(C₁-C₆) alkyl, C₃-C₆ alkynyloxycarbonyl(C₁-C₆)alkyl, (R³O)₂(O═)P(C₁-C₆)alkyl where R³ is hydrogen, C₁-C₄ alkyl or benzyl, C₃-C₇ cycloalkyl (optionally substituted by one to three substituents independently selected from C₁-C₄ alkyl, C₁-C₄ haloalkyl, and C₁-C₄ alkoxy and, additionally, one of the ring member units can optionally represent C═O or C═NR⁴ where R⁴ is hydrogen, C₁-C₄ alkyl, C₁-C₄ haloalkyl, C₁-C₄ cyanoalkyl, C₁-C₄ alkoxy, or C₃-C₆ cycloalkyl), C₃-C₇ halocycloalkyl, C₃-C₇ cycloalkenyl (optionally substituted by one or two substituents independently selected from C₁-C₄ alkyl, and C₁-C₄ haloalkyl, and, additionally, one of the ring member units can optionally represent C═O), C₃-C₇ halocycloalkenyl, C₁-C₆ alkyl-S(═O)n¹(C₁-C₆)alkyl where n¹ is 0, 1 or 2 (optionally substituted by aryl or heteroaryl or heterocyclyl, which themselves can be optionally substituted by one to three substituents independently selected from halogen, cyano, nitro, C₁-C₄ alkyl, C₁-C₄ haloalkyl, and C₁-C₄ alkoxy), C₃-C₆ alkenyl, C₃-C₆ haloalkenyl, aryl(C₃-C₆)alkenyl, C₃-C₆ alkynyl, C₃-C₆ haloalkynyl, aryl(C₃-C₆)alkynyl, C₃-C₆hydroxyalkynyl, C₁-C₆ alkoxycarbonyl (optionally substituted by one to three substituents independently selected from halogen, hydroxy, cyano, C₁-C₄alkoxy, C₁-C₄haloalkyl, and aryl), aryloxycarbonyl (optionally substituted by one to three substituents independently selected from halogen, cyano, nitro, C₁-C₄alkyl, C₁-C₄haloalkyl, C₁-C₄alkoxy), C₃-C₆ alkenyloxycarbonyl, C₃-C₆alkynyloxycarbonyl, C₁-C₆alkylcarbonyl, C₁-C₆haloalkylcarbonyl, aminocarbonyl, C₁-C₆alkylaminocarbonyl, di(C₁-C₆)alkylaminocarbonyl, aminothiocarbonyl, C₁-C₆alkylaminothiocarbonyl, di(C₁-C₆)alkylaminothiocarbonyl, C₁-C₆alkoxy, C₃-C₆ alkenyloxy, C₃-C₈alkynyloxy, aryloxy (optionally substituted by one to three substituents independently selected from halogen, cyano, nitro, C₁-C₄alkyl, C₁-C₄haloalkyl, and C₁-C₄alkoxy), C₁-C₆alkylamino, di(C₁-C₆)alkylamino, C₃-C₆cycloalkylamino, C₁-C₄alkylthio, C₁-C₄alkylsulfinyl, C₁-C₄alkylsulfonyl, C₁-C₄haloalkylsulfonyl, aryl-S(═O)n² (optionally substituted by one or two substituents independently selected from halogen, nitro, and C₁-C₄alkyl) where n² is 0, 1 or 2, aryl (optionally substituted by one to three substituents independently selected from halogen, cyano, nitro, C₁-C₄alkyl, C₁-C₄haloalkyl, C₁-C₄alkoxy, and C₁-C₄haloalkoxy), heteroaryl (optionally substituted by one to three substituents independently selected from halogen, cyano, nitro, C₁-C₄alkyl, C₁-C₄haloalkyl, C₁-C₄alkoxy, and C₁-C₄haloalkoxy), heterocyclyl (optionally substituted by one to three substituents independently selected from halogen, cyano, nitro, C₁-C₄alkyl, C₁-C₄haloalkyl, C₁-C₄alkoxy, and C₁-C₄haloalkoxy, and, additionally, a ring member unit can optionally represent C═O or C═NR⁵ where R⁵ is hydrogen, C1-C4 alkyl, C1-C4 haloalkyl, C1-C4 cyanoalkyl, C1-C4 alkoxy, or C₃-C₆ cycloalkyl), (C₁-C₆ alkylthio)carbonyl, (C₁-C₆ alkylthio)thiocarbonyl, C—C alkyl-S(═O)n³(═NR⁶)—C₁-C₄alkyl wherein R⁶ is hydrogen, cyano, nitro, C₁-C₄alkyl and n³ is 0 or 1, or R² represents a group “—C(R⁷)(R⁸)(R⁹)” wherein R⁷ is C₁-C₄alkyl, C₁-C₄haloalkyl, or cyclopropyl, R⁸ is hydrogen, C₁-C₄alkyl, C₁-C₄haloalkyl, or cyclopropyl, preferably hydrogen, R⁹ is cyano, C₁-C₄alkyl, C₂-C₆ alkenyl, C₂-C₆haloalkenyl, C₁-C₄alkoxy, C₂-C₅ alkynyl, C₂-C₄alkoxycarbonyl, C₁-C₄alkylaminocarbonyl, di(C₁-C₃ alkyl)aminocarbonyl, C₁-C₂haloalkylaminocarbonyl, C₃-C₆alkenyloxycarbonyl, C₃-C₄ alkynyloxycarbonyl, or C₁-C₃ alkylcarbonyl; (arylthio)carbonyl(C₁-C₆)alkyl(wherein aryl can be optionally substituted by one to three substituents independently selected from halogen, cyano, nitro, C₁-C₄ alkyl, C₁-C₄ haloalkyl, and C₁-C₄ alkoxy), (C₁-C₃ alkylthio) carbonyl (C₁-C₆) alkyl (optionally substituted by aryl or heteroaryl or heterocyclyl, which themselves can be optionally substituted by one to three substituents independently selected from halogen, cyano, nitro, C₁-C₄ alkyl, C₁-C₄ haloalkyl, and C₁-C₄ alkoxy), or an agrochemically acceptable salt, N-oxide or isomer thereof.

### Embodiment 2

The composition of embodiment 1, wherein the composition has a pH of 3 to 4.

### Embodiment 3

The composition of embodiments 1 or 2, wherein wherein the composition further comprises

A) a fertilizer,
B) a pH reducer,
C) macronutrients or
D) micronutrients.

### Embodiment 4

The composition as described in embodiments 1, 2, 3, or 4, wherein the said inorganic or organic salt is a mineral acid, phosphorous acid, ammonia, fulvic acid, humic acid, citric acid or carboxylic acid or mixtures thereof.

### Embodiment 5

The composition as described in any of the previous embodiments, wherein the said inorganic or organic salt is nitric acid, phosphoric acid, sulfuric acid, phosphorous acid, ammonia or a C₁ to C₂₀ carboxylic acid or mixture thereof.

### Embodiment 6

The composition as described in any of the previous embodiments, wherein the pH reducer is present and is an organic acid.

### Embodiment 7

The composition as described in any of the previous embodiments, wherein the micronutrient is present and is a water soluble salt of boron, iron, manganese, magnesium, copper or zinc.

### Embodiment 8

The composition as described in any of the previous embodiments, wherein about 20 to about 60% by weight of Si clay granules or Si clay powders based on the amount of the composition.

### Embodiment 9

The composition as described in any of the previous embodiments, wherein about 40 to about 60% by weight of Si clay granules or Si clay powders based on the amount of the composition.

### Embodiment 10

A process for treating a plant which comprises applying the agricultural composition according to embodiments 1-9, in an amount from about 150 pounds to about 4,000 pounds per acre and said Si clay granules or powders are present in the agricultural composition

### Embodiment 11

The process as described in embodiment 10, wherein the composition is applied in an amount from about 250 to about 2000 pounds per acre.

### Embodiment 12

The process as described in embodiment 10 or 11, wherein the composition is applied in an amount from about 250 to about 700 pounds per acre.

### Embodiment 13

The process as described in embodiments 10, 11 or 12, wherein the composition further comprises

A) a fertilizer,
B) a pH reducer,
C) macronutrients or
D) micronutrients

### Embodiment 14

The process as described in embodiments 10, 11, 12 or 13, wherein the said inorganic or organic salt is present and is a mineral acid, phosphorous acid, ammonia, fulvic acid, humic acid, citric acid or carboxylic acid or mixtures thereof.

### Embodiment 15

The process as described in embodiments 10, 11, 12, 13 or 14, wherein the said inorganic or organic salt is nitric acid, phosphoric acid, sulfuric acid, phosphorous acid, ammonia or a C₁ to C₂₀ carboxylic acid or mixture thereof.

### Embodiment 16

The process as described in embodiments 10, 11, 12, 13, 14 or 15, wherein the pH reducer is present and is an organic acid.

### Embodiment 17

The process as described in embodiments 10, 11, 12, 13, 14, 15 or 16, wherein the micronutrient is present and is a water soluble salt of boron, iron, manganese, magnesium, copper or zinc.

### Embodiment 18

The process as described in embodiments 10, 11, 12, 13, 14, 15, 16, or 17, wherein composition is applied to the ground by a band application, broadcast application or strip placement application.

### Embodiment 19

The as described in embodiments 10, 11, 12, 13, 14, 15, 16, 17 or 18, wherein composition is applied within 30 days after the ground has been fertilized.

### Embodiment 20

The process as described in embodiments 10, 11, 12, 13, 14, 15, 16, 17, 18 or 19, wherein said Si clay granules or powders are present in the agricultural composition in an amount from about 40% to about 60% by weight based on the amount of the composition.

### Embodiment 21

The process as described in embodiments 10, 11, 12, 13, 14, 15, 16, 17, 18, 19 or 20, wherein the Si clay is Attapulgite, Montmorillonite or aluminosilcate or a mixture thereof.

### Embodiment 22

The process as described in embodiments 10, 11, 12, 13, 14, 15, 16, 17, 18, 19, 20 or 21, wherein the plant is grass crops, turf crops, cucurbit crops, brassica crops, solanaceae crops, bush berries, citrus, stone fruits, nuts apples, avocado, mangos, lychee or olives.

### Embodiment 23

The process as described in embodiments 10, 11, 12, 13, 14, 15, 16, 17, 18, 19, 20, 21 or 22, wherein the plant is barley, maize, oats, rice, rye, sorghum, wheat, millet, sugar cane or bamboo, Bermuda grass, St. Augustine grass, Zoysia grass, Kentucky bluegrass, Perennial ryegrass, pumpkin, squash, zucchini, cucumber, watermelon, gourd, cabbage, cauliflower, broccoli, mustard, brussel sprouts, turnips/turnip greens, collards, kale, bok choy, tomatoes, tomatillos, eggplant, potatoes, goji berries, tobacco, peppers, sugarcane rice, strawberry, blueberry, blackberry, raspberry, mulberry, elderberry, red currants, white currants, black currents, citron, clementine, grapefruit, oranges, sudachi, shonan gold, satsuma, tangelo, tangerine, limetta, tangor, lemons, limes, citron, yuzu or ugli fruit, peaches, nectarines, plums, peanut, almond, apples, avocado, mangos, lychee or olives.

### Embodiment 24

The process as described in embodiments 10, 11, 12, 13, 14, 15, 16, 17, 18, 19, 20, 21, 22 or 23, wherein the composition which comprises Si clay granules or Si clay powders and an inorganic or organic salt or a mixture thereof, wherein the composition is applied in an amount from about 250 pounds to about 2,000 pounds per acre and wherein said Si clay granules or powders are present in the agricultural composition in an amount from about 40% to about 60% by weight based on the amount of the composition.

### Embodiment 25

The process as described in embodiments 10, 11, 12, 13, 14, 15, 16, 17, 18, 19, 20, 21, 22, 23 or 24, wherein there is sufficient soluble Si in the soil profile for plant availability and to maintain a leaf level Si not to be less than 0.6%.

### Embodiment 26

The process as described in embodiments 10, 11, 12, 13, 14, 15, 16, 17, 18, 19, 20, 21, 22, 23, 24 or 25, wherein the Si clay granules or Si clay powders are montmorillonite.

### Embodiment 27

The process as described in embodiments 10, 11, 12, 13, 14, 15, 16, 17, 18, 19, 20, 21, 22, 23, 24, 25 or 26, wherein the Si clay granules or Si clay powders are attapulgite.

### Embodiment 28

The process as described in embodiments 10, 11, 12, 13, 14, 15, 16, 17, 18, 19, 20, 21, 22, 23, 24, 25, 26 or 27, wherein the Si clay granules or Si clay powders are Hydrous Aluminosilicate.

### Embodiment 29

The process as described in embodiments 10, 11, 12, 13, 14, 15, 16, 17, 18, 19, 20, 21, 22, 23, 24, 25, 26, 27 or 28, wherein the Si clay granules or Si clay powders are present in an amount from about 40% to about 60% by weight based on the amount of the composition, and

the organic and inorganic acid are selected from the group consisting of
a. nitric acid,
b. phosphoric acid,
c. sulfuric acid, and
d. mixtures of a, b and/or c,
e. phosphorous acid,
f. ammonia,
g. fulvic acid,
h. humic acid,
i. citric acid and
j. C₁ to C₂₀ carboxylic acid, and
applying the fertilizer composition in an amount from 400 to 700 pounds per acre.

### Embodiment 30

A process of rendering Si into a plant available form which comprises increasing the acidity of a fertilizer composition comprising

a fertilizer,
an organic or inorganic acid, and
Si clay granules or Si clay powders wherein the Si clay granules or Si clay powders are an amount from about 20% to about 90% by weight based on the amount of the composition,
and the fertilizer composition is applied to the soil wherein the organic or inorganic acid serves to reduce the pH of the soil within a placement zone of the fertilizer and triggers the process of converting SiO₄ to SiO₂.

### Embodiment 31

The process as described in embodiment 30, wherein the Si clay granules or Si clay powders are present in an amount from about 40% to about 60% by weight based on the amount of the composition, and

the organic and inorganic acid are selected from the group consisting of
a. nitric acid,
b. phosphoric acid,
c. sulfuric acid, and
d. mixtures of a, b and/or c,
e. phosphorous acid,
f. ammonia,
g. fulvic acid,
h. humic acid,
i. citric acid and
j. C₁ to C₂₀ carboxylic acid.

### Embodiment 32

The process as embodiments 30 and 31, wherein the Si clay granules or Si clay powders are Attapulgite.

### A BRIEF DESCRIPTION OF THE FIGURES

FIG. 1 illustrates 21 tissue samples over a 15 month period using Agsorb Silicon (AgSi) compared to conventional (conv.).

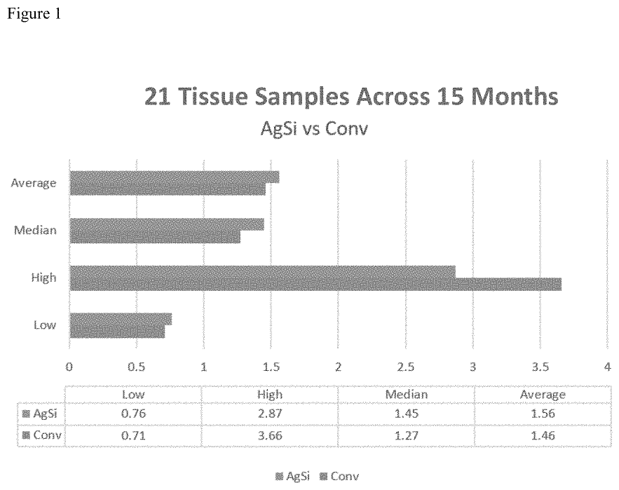

FIG. 2 illustrates the same 21 tissue samples over a 15 month period using AgSi compared to conv. as shown if FIG. 1. FIG. 2 illustrates the optimum silicon lever in sugarcane is 0.6% and above and the critical Si levels are below 0.5%. FIG. 2 represents one set of field trials with a duration from plant through the current crop stage.

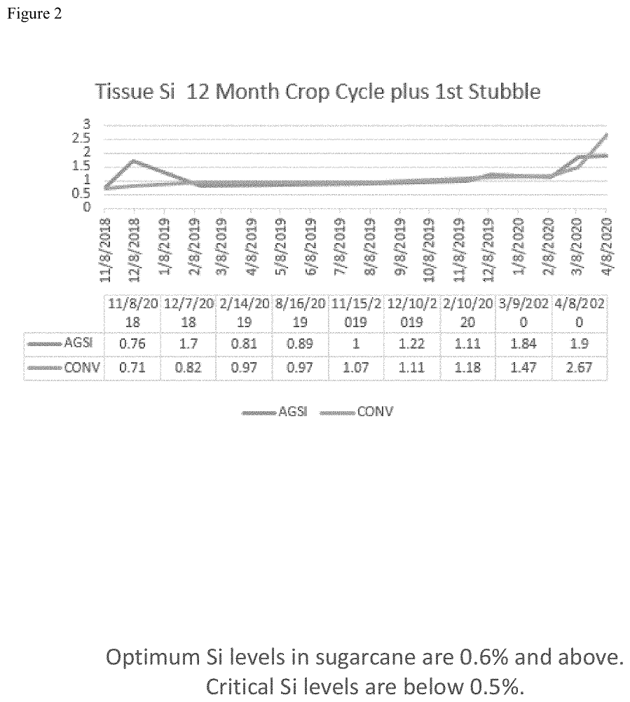

FIG. 3 illustrates the dis-solution of SiO₂ over a five month period.

FIG. 4 illustrates the average dis-solution (DSS) of SiO₂ over the same five month period as shown in FIG. 3.

FIG. 5 illustrates the dis-solution of Mn over the same five month period as shown in FIG. 3.

FIG. 6 illustrates the dis-solution of K₂O over the same five month period as shown in FIG. 3.

### A DETAILED DESCRIPTION OF THE INVENTION

The invention relates to an agricultural composition comprising Si clay granules which can be applied to the soil in an in an amount from about 150 pounds to about 4,000 pounds per acre, preferably about 250 pounds to about 2,000 pounds per acre and ever more preferably from about 300 pounds to about 750 pounds per acre and most preferably about 400 pounds to about 700 pounds per acre. The agricultural composition can be applied after the soil has been fertilized. Generally, the first application would be less than 90 days after the soil has been fertilized, and it could be than 60 days, and even less than 30 and usually less 15 days. The agricultural composition can be also applied in more than one applications (multiple applications) for the planting cycle. For example, the agricultural composition can be applied in at least 1, 2, 3, 4, 5, 6, 7 or 8 applications.

The agricultural composition preferably contains either organic and/or inorganic salts.

The agricultural composition can also contain a fertilizer. The agricultural composition also does not require a fertilizer and exclude a fertilizer.

The invention relates to a fertilizer composition comprising a fertilizer and Si clay granules wherein the Si clay is an amount from about 10 to about 90% by weight based on the total amount of the fertilizer and Si clay.

The fertilizer composition can be used for plants such as, but not limited to grass crops, turf crops, cucurbit crops, brassica crops, solanaceae crops, bush berries, citrus, stone fruits, nuts or other crops.

Grass crops include but are not limited to barley, maize (corn), oats, rice, rye, sorghum, wheat, millet, sugar cane or bamboo.

Turf crops include but are not limited to Bermuda grass, St. Augustine grass, Zoysia grass, Kentucky bluegrass or Perennial ryegrass.

Cucurbit crops include but are not limited to pumpkin, squash, zucchini, cucumber, watermelon or gourd.

Brassica Crops include but are not limited to cabbage, cauliflower, broccoli, mustard, brussel sprouts, turnips/turnip greens. collards, kale or bok choy.

Solanaceae crops include but are not limited to tomatoes, tomatillos, eggplant, potatoes, goji berries, tobacco, peppers (bell peppers, chili peppers, paprika, tamales, tomatillos, pimentos, cayenne, etc).

Bush berries, such as, but not limited to, strawberry, blueberry, blackberry, raspberry, mulberry, elderberry, red currants, white currants, and black currents.

Citrus, such as, but not limited to, citron, clementine, grapefruit, oranges, sudachi, shonan gold, satsuma, tangelo, tangerine, limetta, tangor, lemons, limes, citron, yuzu or ugli fruit.

Stone fruits, such as, but not limited to peaches, nectarines and plums would also work.

Nuts, such as, but not limited to peanut and almond would also work.

Other crops such as, but not limited to apples, avocado, mangos, lychee and olives.

The fertilizer can be any fertilizer such as a fertilizer containing Nitrogen, Phosphorous and potassium (K) referred to as “NPK” or a fertilizer which does not contain any nitrogen referred to as a XPK. The fertilizer contain boron, zinc, copper, iron, blends of nitrogen phosphorous and potash or mixtures thereof.

The fertilizer can be ammonia sulfate, an ammonia salt of a carboxylic acid, mono- or di-potassium phosphate, a micronutrient, ammonia nitrate, urea, ammonia citrate or ammonia acetate.

The Si clay can be any Si clay. The Si clay is preferably, Agsorb® which is granules that include Montmorillonite from Ripley Miss. or from Mounds Ill., Attapulgite from Ochlocknee Ga., Hydrous Aluminosilicate from Taft, Calif. and Verge™ also from Oil-Dri.

Prior to the invention it was known to use a conditioner such as Si clay up to 100 pounds per ton fertilizer. I have found that it is much better to increase the amount of Si clay and it should be in an amount from about 200 to about 1800 pounds to the ton fertilizer. In other words, the amount of the Si clay is from about 10% by weight to about 90% by weight, and can be any percentage between 10 to 90%, such as, 10, 12, 14, 16, 18, 20, 22, 24, 25, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88 or 90% by weight of the total weight of composition.

Optional components can be pH reducer, macronutrients and micronutrients.

A pH reducer can be used to lower the pH of the fertilizer composition would be greater than 10, such as about 12. The pH reducer can be any acid such as an organic acid, such as but not limited to citric acid or carboxylic acid or Essence 6 from Helena Agri-Enterprises LLC (Helena). Essence 6 is a concentrated organic acid complex. Its low pH, clear amber liquid formulation will also clear drip irrigation lines. Essence 6 contains Helena's NutrAsyst Formulation Technology (NFT), a high quality blend of organic acids that is designed to improve the performance of liquid fertilizers. About 2 quarts per acre.

The composition can contain macronutrients such as, but not limited to, nitrogen, phosphorus, potassium, sulfur, calcium, and magnesium are needed by plants in relatively large quantities and are therefore called macronutrients as discussed above.

The composition can contain micronutrients such as, but not limited to a water soluble salt of boron, iron, manganese, magnesium, copper or zinc as discussed above.

The fertilizer composition according to the invention should be applied to the soil in an amount from about 150 pounds to about 4,000 pounds per acre, can be an amount between 150 pounds to 4,000 pounds such as from about 250 pounds to about 2,000 pounds per acre and from about 300 pounds to about 750 pounds per acre and about 400 pounds to about 700 pounds per acre.

Sugarcane fertilization requires around 600 pounds of custom fertilizer at planting and 200-300 pounds 3-5 times through the crop cycle (12 months). I was able to incorporate this SiO₂ product with the fertilizer blend in any of these application slots and therefore take advantage of the timing and rate piece of the input strategy.

### EXAMPLES

Two examples were made with one example using a first sample according to the invention using Agsorb® and the second example with a calcium silicate slag. I compared the results and evaluated with respect to Si. The results are as shown in Table 4 below:

TABLE 4
Neither examples 1 nor 2 contain fertilizer.

| Example 1 according | | |
|---|---|---|
| to the invention | | |
| contains non-treated | | |
| AgSorb | | |
| Calcium | 1.49% | |
| Magnesium (Total) | 2.22% | |
| Magnesium (Water Soluble) | 0.05% | |
| Aluminum | 2.61% | |
| Total Silicon | 41.20% | |
| Extractable Silicon | 1449.42 | ppm |
| Mehlich 3 (M3) SiO₄ | | |
| Example 2 using | | |
| calcium silicate slag | | |
| Calcium | 23.40% | |
| Magnesium (Total) | 2.16% | |
| Magnesium (Water Soluble) | 0.01% | |
| Aluminum | 1.74% | |
| Total Silicon | 4.12% | |
| Extractable Silicon | 832.46 | ppm |

Mehlich 3 (M3) SiO₄

W = Wet (as received) BASIS

Two samples of each, were evaluated as a fertilizer source and the Agsorb® rendered 10× available SiO₂ than the slag source. In addition to that, I evaluated each source for soluble Si as well and the Agsorb® had 50% more soluble (immediately available) Si.

I checked two samples of each product using 50 grams of each product was added to 200 ml of distilled water for 30 day with random, equivalent agitation. Samples were evaluated as a fertilizer. Filtrate is the solid caught in 50 micron filter, water soluble is the liquid that passed through the filter Slag. The results are shown in Table 5 below:

TABLE 5

| | Water | Filtrate: | Raw: |
|---|---|---|---|
| | solubable | Total | Total |
| | SiO₂ | SiO₂ | SiO₂ |
| Agsorb | 1.99% | 37.05% | 47.05% |
| Slag | 1.43% | 5.93% | 4.90% |

Two examples were made with one example using a first sample according to the invention using Agsorb® and the second example with a calcium silicate slag. I compared the results and evaluated with respect to Si. Two examples with the agricultural composition containing slag and three containing AgSorb on different fields containing a different amount of acreage as shown in Tables 6 and 7 below. The chemical make-up of these examples 1 (according to the invention contains non-treated AgSorb) and example 2 (using calcium silicate slag) are shown above in Table 4.

TABLE 6
Slag

| | | | | | Lbs |
|---|---|---|---|---|---|
| Harv | Harv | | | | Sug |
| Total | Total | Harv | Percent | Percent | Per |
| Acres | Tons | TPA | Sucrose | Yield | Acre |
| 67.38 | 4,005.48 | 59.45 | 14.49 | 11.64 | 13,843 |
| 63.99 | 3,908.08 | 61.07 | 14.34 | 11.46 | 14,022 |
| 74.57 | 4,530.39 | 60.75 | 14.32 | 11.26 | 13,679 |
| 71.53 | 4,301.66 | 60.14 | 14.18 | 11.18 | 13,454 |
| 68.39 | 4,060.99 | 59.38 | 14.82 | 11.68 | 13,877 |
| 345.86 | 20,806.80 | 60.16 | 14.43 | 11.45 | 13,775 |

TABLE 7
AgSorb

| | | | | | Lbs |
|---|---|---|---|---|---|
| Harv | Harv | | | | Sug |
| Total | Total | Harv | Percent | Percent | Per |
| Acres | Tons | TPA | Sucrose | Yield | Acre |
| 72.63 | 4,298.89 | 59.19 | 14.40 | 11.49 | 13,606 |
| 70.51 | 4,342.06 | 61.58 | 14.11 | 11.17 | 13,755 |
| 69.45 | 4,185.25 | 60.26 | 14.12 | 11.10 | 13,378 |
| 212.59 | 12,826.20 | 60.33 | 14.21 | 11.25 | 13580 |

It is noted that the last line of table 6 and 7 which appear below the line are a total for harvested total acres and harvest total tons. However, the next four columns, Harvest tons per acre (TPA) Percent Sucrose, Percent Yield and pounds (lbs) Sugar (Sug) per acre are the average for each of the columns. The AgSorb (AgSi) is delivering equivalent yields as a Si source compared to conventional. Cost/acre is more economical and logistically easier to apply.

The following is yield data shown in Table 8 from other field demonstrations using AgSorb (AgSi) versus conventional treatment (using slag).

TABLE 8

| | AgSi | | | | Conventional treatment (slag) | | | |
|---|---|---|---|---|---|---|---|---|
| | | | Lbs | | | | Lbs | |
| | Harv | Harv | Sug | | Harv | Harv | Sug | |
| | Total | Total | Per | Harv | Total | Total | Per | Harv |
| | Acres | Tons | Acre | TPA | Acres | Tons | Acre | TPA |
| | 12.28 | 704.14 | 12,380 | | 12.78 | 794.75 | 13,691 | |
| | 7.99 | 640.03 | 17,608 | | 12.60 | 625.51 | 10,669 | |
| | 10.79 | 632.47 | 12,795 | | 8.66 | 600.99 | 15,337 | |
| | 9.20 | 624.46 | 16,228 | | 9.50 | 674.46 | 15,550 | |
| | 7.27 | 561.64 | 17,407 | | 6.92 | 529.37 | 16,975 | |
| | 7.62 | 483.13 | 14,772 | | 7.67 | 551.92 | 15,808 | |
| | 7.76 | 479.28 | 13,984 | | 7.87 | 537.34 | 14,534 | |
| | 7.95 | 457.05 | 12,759 | | 5.75 | 478.00 | 17,426 | |
| | 7.49 | 451.50 | 14,306 | | | | | |
| | 7.95 | 618.68 | 17,059 | | | | | |
| Total | 86.30 | 5,652.38 | 149,298 | 65.50 | 71.75 | 4,792.34 | 119,990 | 66.79 |

Of all samples taken, highest, lowest and average results were extracted and tabled. Highest number not relative to yield. Leaf levels need to remain above 0.6% to be sufficient for Si.

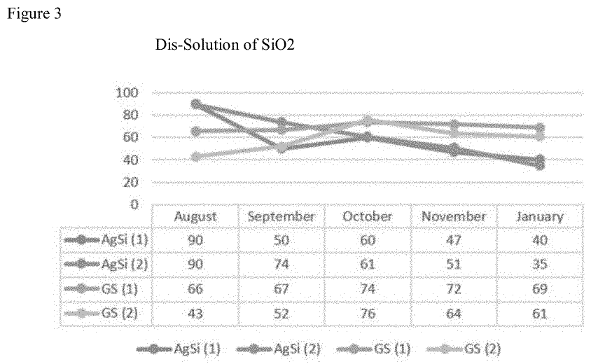

I checked samples using 50 grams of the treated material and added 200 ml of distilled water and allow it to hydrolysis to act upon the material over time. As a part of the procedure, the treatment would be shaken well 2 to 3 times per week with 4 to 5 weeks the period between samples. All the samples were treated the same. Samples (25 ml) were drawn form the clear solution part of the treatment evaluation, then replaced with 25 ml of distilled water in order to initiate the next step of the DDS. Samples were evaluated for the SiO₂ (available silicon, manganese and potassium). The results are shown in FIGS. 3, 4, 5 and 6.

Ag(1) and Ag(2) are the same composition as example 1 above disclosed in table 4. GS (1) and GS (2) are the same composition as disclosed for example 2 using calcium silicate slag. This is also referred to as conventions. There are 2 reps for each composition.

FIG. 3 illustrates an advantage of the dis-solution of SiO₂. Since the inventive composition requires a higher amount of SiO₂ compared to the prior art. GS (1) and GS (2). The amount of SiO₂ in AgSi(1) and AgSi (2) starts at 90 in August and in January is less than half (40 and 35). The dis-solution of GS (1) and (2) does not occur. The SiO₂ for GS (1) in August is 66 and the amount of SiO₂ increases 5 months later in January to 69. The SiO₂ for GS (2) in August is 43 and the amount of SiO₂ increases 5 months later in January to 61. The goal is to render sufficient soluble Si in the soil profile for plant availability and to maintain a leaf level Si not to be less than 0.6%. The dis solution test is not soil content related.

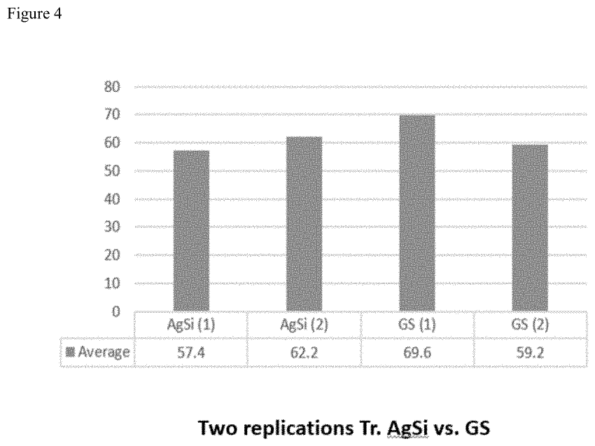

FIG. 4 shows the average dissolution (DDS) SiO₂ from August through January. FIG. 4 shows sufficient release of Si from the clay particle that is a soluble source of Si for the crop. In FIG. 4, the abbreviation for Tr. AgSi is treated AgSorb and GS again is example 2 (using calcium silicate slag).

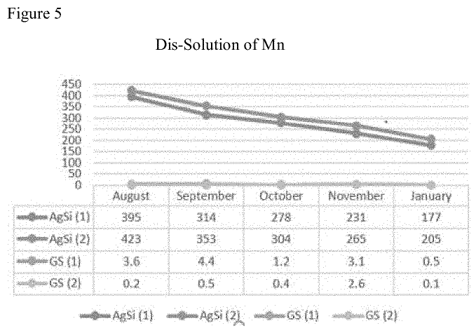

FIG. 5 illustrates an advantage of the dis-solution of Mn where GS1 and GS (2) are almost identical and are substantially lower than that of AgSi(1) and AgSi(2). The content of manganese (Mn) reduces over time. However, according to the composition of invention although Mn reduces over time (from August to January—after 5 months) there is a high range of Mn from 177 to 205 remaining in the soil. However, the GS (1) and GS(2) only start at 3.6 and 0.2 for the Mn and after the same time period reduce to only 0.5 to 0.1 respectively. There is not nearly as much manganese remaining in the soil using GS (1) and GS (2). The composition according to the invention has a significantly higher amount of manganese remaining in the soil. This is due to the treatment of complex acids applied to AgSi.

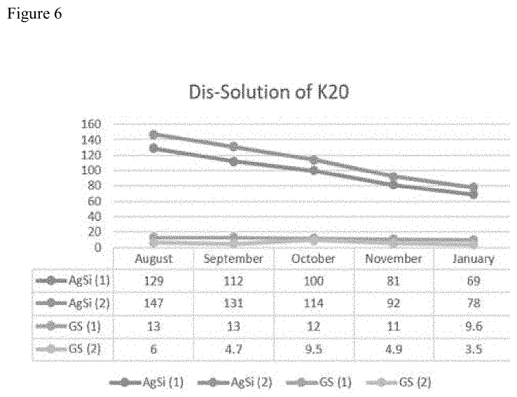

FIG. 6 illustrates an advantage of the dis-solution of K₂O where GS1 and GS (2) are almost identical and are substantially lower than that of AgSi (1) and AgSi(2). The content of K₂O reduces over time. However, according to the composition of invention reduces over time (from August to January—after 5 months) there is a range of potassium from 69 to 78 (K₂O) remaining in the soil. However, the GS (1) and GS(2) only start at 13 and 6 for the K₂O and after the same time period reduce to only 3.5 to 9.6 respectively. There is not nearly as much potassium remaining in the soil using GS (1) and GS (2). The composition according to the invention has a significantly higher amount of potassium remaining in the soil.

All ranges disclosed herein are inclusive of the endpoints, and the endpoints are independently combinable with each other (e.g., ranges of “10% to 90%, is inclusive of the endpoints and all intermediate values of the ranges of “10 to 90” etc.). “Combination” is inclusive of blends, mixtures, alloys, reaction products, and the like. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

All the references described above are incorporated by reference for all useful purposes.

We claim:

1. An agricultural composition which comprising
a) about 10 to about 90% by weight of Si clay granules or Si clay powders based on the amount of the composition and
b) inorganic or organic acids,
and wherein the composition has a pH of 2 to 5.

2. The agricultural composition according to claim 1, wherein the composition does not contain a compound of the formula (I) 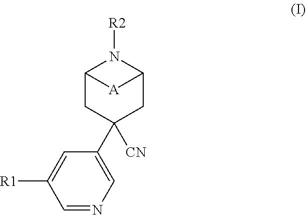
A is —CH₂—CH₂— or —CH═CH—;
R¹ is halogen; and
R² is hydrogen, formyl, cyano, hydroxy, NH, C₁-C₆ alkyl which is optionally substituted by aryl, aryloxy, heteroaryl or hetero-cyclyl, which themselves can be optionally substituted by one to three substituents independently selected from halogen, cyano, nitro, C₁-C₄ alkyl, C₁-C₄ haloalkyl, and C₁-C₄ alkoxy), C₁-C₆ haloalkyl (optionally substituted by one to two substituents independently selected from hydroxy, C₁-C₄-alkoxy, tri(C₁-C₄alkyl)silyloxy, C₁-C₂alkylcarbonyloxy, and C₃-C₅ alkenyl), C₁-C₆ cyanoalkyl, C₁-C₆ alkoxy(C₁-C₆) alkyl (optionally substituted by aryl or heteroaryl, which themselves can be optionally substituted by one to three substituents independently selected from halogen, cyano, nitro, C₁-C₄alkyl, C₁-C₄haloalkyl, and C₁-C₄ alkoxy), C₁-C₄ alkoxy(C₁-C₄)alkoxy(C₁-C₄)alkyl, C₁-C₆ alkylcarbonyl(C₁-C₆)alkyl, C₁-C₄alkoxyimino(C₁-C₄)alkyl, C₁-C₄ haloalkoxy(C₁-C₄)alkyl, C₁-C₆ alkoxycarbonyl(C₁-C₆)alkyl, C₁-C₄ alkoxy(C₁-C₄) alkoxycarbonyl(C₁-C₆)alkyl, hydroxycarbonyl(C₁-C₆)alkyl, aryloxycarbonyl(C₁-C₆)alkyl (wherein the aryl group can be optionally substituted by one or two substituents independently selected from halogen, cyano, nitro, C₁-C₄alkyl, C₁-C₄ haloalkyl, and C₁-C₄ alkoxy), C₁-C₄ alkylaminocarbonyl(C₁-C₆)alkyl, di(C₁-C₄ alkyl)aminocarbonyl(C₁-C₆)alkyl, C₁-C₄haloalkylaminocarbonyl(C₁-C₆)alkyl, di(C₁-C₄ haloalkyl)aminocarbonyl-C₁-C₆ alkyl, C₁-C₂ alkoxy(C₂-C₄)alkylaminocarbonyl(C₁-C₄)alkyl, C₂-C₆ alkenyloxycarbonyl (C₁-C₆) alkyl, C₃-C₆ alkynyloxycarbonyl(C₁-C₆)alkyl, (R³O)₂(O═)P(C₁-C₆)alkyl where R³ is hydrogen, C₁-C₄ alkyl or benzyl, C₃-C₇ cycloalkyl (optionally substituted by one to three substituents independently selected from C₁-C₄ alkyl, C₁-C₄ haloalkyl, and C₁-C₄ alkoxy and, additionally, one of the ring member units can optionally represent C═O or C=NR⁴ where R⁴ is hydrogen, C₁-C₄ alkyl, C₁-C₄ haloalkyl, C₁-C₄ cyanoalkyl, C₁-C₄ alkoxy, or C₃-C₆ cycloalkyl), C₃-C₇ halocycloalkyl, C₃-C₇ cycloalkenyl (optionally substituted by one or two substituents independently selected from C₁-C₄ alkyl, and C₁-C₄ haloalkyl, and, additionally, one of the ring member units can optionally represent C═O), C₃-C₇ halocycloalkenyl, C₁-C₆ alkyl-S(═O)n¹(C₁-C₆)alkyl where n¹ is 0, 1 or 2 (optionally substituted by aryl or heteroaryl or heterocyclyl, which themselves can be optionally substituted by one to three substituents independently selected from halogen, cyano, nitro, C₁-C₄ alkyl, C₁-C₄ haloalkyl, and C₁-C₄ alkoxy), C₃-C₆ alkenyl, C₃-C₆ haloalkenyl, aryl(C₃-C₆)alkenyl, C₃-C₆ alkynyl, C₃-C₆ haloalkynyl, aryl(C₃-C₆)alkynyl, C₃-C₆hydroxyalkynyl, C₁-C₆ alkoxycarbonyl (optionally substituted by one to three substituents independently selected from halogen, hydroxy, cyano, C₁-C₄alkoxy, C₁-C₄haloalkyl, and aryl), aryloxycarbonyl (optionally substituted by one to three substituents independently selected from halogen, cyano, nitro, C₁-C₄alkyl, C₁-C₄haloalkyl, C₁-C₄alkoxy), C₃-C₆ alkenyloxycarbonyl, C₃-C₆alkynyloxycarbonyl, C₁-C₆alkylcarbonyl, C₁-C₆haloalkylcarbonyl, aminocarbonyl, C₁-C₆alkylaminocarbonyl, di(C₁-C₆)alkylaminocarbonyl, aminothiocarbonyl, C₁-C₆alkylaminothiocarbonyl, di(C₁-C₆)alkylaminothiocarbonyl, C₁-C₆alkoxy, C₃-C₆ alkenyloxy, C₃-C₈alkynyloxy, aryloxy (optionally substituted by one to three substituents independently selected from halogen, cyano, nitro, C₁-C₄alkyl, C₁-C₄haloalkyl, and C₁-C₄alkoxy), C₁-C₆alkylamino, di(C₁-C₆)alkylamino, C₃-C₆cycloalkylamino, C₁-C₄alkylthio, C₁-C₄alkylsulfinyl, C₁-C₄alkylsulfonyl, C₁-C₄haloalkylsulfonyl, aryl-S(═O)n² (optionally substituted by one or two substituents independently selected from halogen, nitro, and C₁-C₄alkyl) where n² is 0, 1 or 2, aryl (optionally substituted by one to three substituents independently selected from halogen, cyano, nitro, C₁-C₄alkyl, C₁-C₄haloalkyl, C₁-C₄alkoxy, and C₁-C₄haloalkoxy), heteroaryl (optionally substituted by one to three substituents independently selected from halogen, cyano, nitro, C₁-C₄alkyl, C₁-C₄haloalkyl, C₁-C₄alkoxy, and C₁-C₄haloalkoxy), heterocyclyl (optionally substituted by one to three substituents independently selected from halogen, cyano, nitro, C₁-C₄alkyl, C₁-C₄haloalkyl, C₁-C₄alkoxy, and C₁-C₄haloalkoxy, and, additionally, a ring member unit can optionally represent C═O or C═NR⁵ where R⁵ is hydrogen, C1-C4 alkyl, C1-C4 haloalkyl, C1-C4 cyanoalkyl, C1-C4 alkoxy, or C₃-C₆ cycloalkyl), (C₁-C₆ alkylthio)carbonyl, (C₁-C₆ alkylthio)thiocarbonyl, C—C alkyl-S(═O)n³(═NR⁶)—C₁-C₄alkyl wherein R⁶ is hydrogen, cyano, nitro, C₁-C₄alkyl and n³ is 0 or 1, or R² represents a group “—C(R⁷)(R⁸)(R⁹)” wherein R⁷ is C₁-C₄alkyl, C₁-C₄haloalkyl, or cyclopropyl, R⁸ is hydrogen, C₁-C₄alkyl, C₁-C₄haloalkyl, or cyclopropyl, preferably hydrogen, R⁹ is cyano, C₁-C₄alkyl, C₂-C₆ alkenyl, C₂-C₆haloalkenyl, C₁-C₄alkoxy, C₂-C₅ alkynyl, C₂-C₄alkoxycarbonyl, C₁-C₄alkylaminocarbonyl, di(C₁-C₃ alkyl)aminocarbonyl, C₁-C₂haloalkylaminocarbonyl, C₃-C₆alkenyloxycarbonyl, C₃-C₄ alkynyloxycarbonyl, or C₁-C₃ alkylcarbonyl; (arylthio)carbonyl(C₁-C₆)alkyl(wherein aryl can be optionally substituted by one to three substituents independently selected from halogen, cyano, nitro, C₁-C₄ alkyl, C₁-C₄ haloalkyl, and C₁-C₄ alkoxy), (C₁-C₃ alkylthio) carbonyl (C₁-C₆) alkyl (optionally substituted by aryl or heteroaryl or heterocyclyl, which themselves can be optionally substituted by one to three substituents independently selected from halogen, cyano, nitro, C₁-C₄ alkyl, C₁-C₄ haloalkyl, and C₁-C₄ alkoxy), or an agrochemically acceptable salt, N-oxide or isomer thereof.

3. The composition as claimed in claim 1, wherein the composition has a pH of 3 to 4.

4. The composition as claimed in claim 1, which further comprises
A) a fertilizer,
B) a pH reducer,
C) macronutrients or
D) micronutrients.

5. The composition as claimed in claim 1, wherein the said inorganic or organic salt is a mineral acid, phosphorous acid, ammonia, fulvic acid, humic acid, citric acid or carboxylic acid or mixtures thereof.

6. The composition as claimed in claim 1, wherein the said inorganic or organic salt is nitric acid, phosphoric acid, sulfuric acid, phosphorous acid, ammonia or a C₁ to C₂₀ carboxylic acid or mixture thereof.

7. The composition as claimed in claim 4, which requires the pH reducer and the pH reducer is an organic acid.

8. The composition as claimed in claim 4, wherein the micronutrient is present and is a water soluble salt of boron, iron, manganese, magnesium, copper or zinc.

9. The composition as claimed in claim 1, wherein about 20 to about 60% by weight of Si clay granules or Si clay powders based on the amount of the composition.

10. The composition as claimed in claim 1, wherein about 40 to about 60% by weight of Si clay granules or Si clay powders based on the amount of the composition.

11. The agricultural composition according to claim 1, wherein the composition does not contain an insecticide.

12. A process of treating a plant which comprises applying the agricultural composition as claimed in claim 1 in an amount from about 150 pounds to about 4,000 pounds per acre.

13. The process as claimed in claim 12, wherein the composition is applied in an amount from about 250 to about 2000 pounds per acre.

14. The process as claimed in claim 12, wherein the composition is applied in an amount from about 250 to about 700 pounds per acre.

15. The process as claimed in claim 12, wherein the composition further comprises
A) a fertilizer,
B) a pH reducer,
C) macronutrients or
D) micronutrients.

16. The process as claimed in claim 12, wherein the said inorganic or organic salt is a mineral acid, phosphorous acid, ammonia, fulvic acid, humic acid, citric acid or carboxylic acid or mixtures thereof.

17. The process as claimed in claim 12, wherein the said inorganic or organic salt is nitric acid, phosphoric acid, sulfuric acid, phosphorous acid, ammonia or a C₁ to C₂₀ carboxylic acid or mixture thereof.

18. The process as claimed in claim 15, wherein the pH reducer is present and is an organic acid.

19. The process as claimed in claim 15, wherein the micronutrient is present and is a water soluble salt of boron, iron, manganese, magnesium, copper or zinc.

20. The process as claimed in claim 12, wherein composition is applied to the ground by a band application, broadcast application or strip placement application.

21. The process as claimed in claim 12, wherein composition is applied within 30 days after the ground has been fertilized.

22. The process as claimed in claim 15, wherein said Si clay granules or powders are present in the agricultural composition in an amount from about 40% to about 60% by weight based on the amount of the composition.

23. The process as claimed in claim 12, wherein the Si clay is Attapulgite, Montmorillonite or aluminosilcate or a mixture thereof.

24. The process as claimed in claim 12, wherein the plant is grass crops, turf crops, cucurbit crops, brassica crops, solanaceae crops, bush berries, citrus, stone fruits, nuts apples, avocado, mangos, lychee or olives.

25. The process as claimed in claim 12, wherein the plant is barley, maize, oats, rice, rye, sorghum, wheat, millet, sugar cane or bamboo, Bermuda grass, St. Augustine grass, Zoysia grass, Kentucky bluegrass, Perennial ryegrass, pumpkin, squash, zucchini, cucumber, watermelon, gourd, cabbage, cauliflower, broccoli, mustard, brussel sprouts, turnips/turnip greens, collards, kale, bok choy, tomatoes, tomatillos, eggplant, potatoes, goji berries, tobacco, peppers, sugarcane rice, strawberry, blueberry, blackberry, raspberry, mulberry, elderberry, red currants, white currants, black currents, clementine, grapefruit, oranges, sudachi, shonan gold, satsuma, tangelo, tangerine, limetta, tangor, lemons, limes, citron, yuzu or ugli fruit, peaches, nectarines, plums, peanut, almond, apples, avocado, mangos, lychee or olives.

26. The process as claimed in claim 12, wherein the composition comprises
Si clay granules or Si clay powders and
an inorganic or organic salt or a mixture thereof,
wherein the composition is applied in an amount from about 250 pounds to about 2,000 pounds per acre and wherein said Si clay granules or powders are present in the agricultural composition in an amount from about 40% to about 60% by weight based on the amount of the composition.

27. The process as claimed in claim 26, wherein there is sufficient soluble Si in the soil profile for plant availability and to maintain a leaf level Si not to be less than 0.6%.

28. The process as claimed in claim 12, wherein the Si clay granules or Si clay powders are present in an amount from about 40% to about 60% by weight based on the amount of the composition, and
the organic and inorganic acid are selected from the group consisting of
a. nitric acid,
b. phosphoric acid,
c. sulfuric acid, and
d. mixtures of a, b and/or c,
e. phosphorous acid,
f. ammonia,
g. fulvic acid,
h. humic acid,
i. citric acid and
j. C₁ to C₂₀ carboxylic acid, and
applying the fertilizer composition in an amount from 400 to 700 pounds per acre.

29. A process of rendering Si into a plant available form which comprises increasing the acidity of a fertilizer composition comprising
a fertilizer,
and the composition according to claim 1,
and the fertilizer composition is applied to the soil wherein the organic or inorganic acid serves to reduce the pH of the soil within a placement zone of the fertilizer and triggers the process of converting SiO₄ to SiO₂.

30. The process as claimed in claim 29, wherein the Si clay granules or Si clay powders are present in an amount from about 40% to about 60% by weight based on the amount of the composition, and
the organic and inorganic acid are selected from the group consisting of
a. nitric acid,
b. phosphoric acid,
c. sulfuric acid, and
d. mixtures of a, b and/or c,
e. phosphorous acid,
f. ammonia,
g. fulvic acid,
h. humic acid,
i. citric acid and
j. C₁ to C₂₀ carboxylic acid.
